(19) United States
(12) Patent Application Publication
(10) Pub. No.: US 2007/0171529 A1
(43) Pub. Date: Jul. 26, 2007

(54) Method for manufacturing optical element

(75) Inventor: Ping Chuang, Kwei-Shan Hsiang (TW)

Correspondence Address: BIRCH STEWART KOLASCH & BIRCH, PO BOX 747, FALLS CHURCH, VA, 22040-0747, US

(73) Assignee: SPEED TECH CORP., Kwei-Shan Hsiang (TW)

(21) Appl. No.: 11/724,204

(22) Filed: Mar. 15, 2007

Related U.S. Application Data
(62) Division of application No. 11/258,125, filed on Oct. 26, 2005, now abandoned.

(51) Int. Cl. G02B 5/124

(52) U.S. Cl. 359/530

(57) ABSTRACT

The present invention provides an optical element for diffusing and focusing light. The optical element comprises an optical substrate and a plurality of convexes thereon, wherein the convexes are micrometer-scaled or smaller pyramid structures.

### RELATED APPLICATIONS

This application is a divisional application of U.S. application Ser. No. 11/258,125, filed Oct. 26, 2005, the full disclosure of which is incorporated herein by reference.

### BACKGROUND

1. Field of Invention

The present invention relates to an optical element. More particularly, the present invention relates to an optical element for diffusing and focusing light.

2. Description of Related Art

Planar light sources with even brightness are hard to generate because of manufacturing limitations of light sources and light emitting devices such as light emitting diodes (LED), which generate point light sources, and cold cathode fluorescent lamps (CCFL), which generate linear light sources. When a product requires a planar light source, an optical element that can diffuse light is conventionally present in the product so as to diffuse the light emitted from the light sources. In addition, the product should also comprise another focusing element so that the light can be focused to the front. A typical example is a back light module of a liquid crystal display (LCD). The backlight module of the LCD comprises at least two optical elements, i.e. a diffuser and a prism, such that the light emitted to the front is homogeneous and has increased brightness.

When several optical elements are used to homogenize and focus light, light is absorbed by the optical elements and cannot completely pass through the optical elements, which results in decreased utilization of the light. Furthermore, the optical elements age through absorbing light such that the optical properties of the transmitted light, such as color saturation, change. Therefore, there is a need for reducing the number of the optical elements used to resolve the problems mentioned above.

### SUMMARY

It is therefore an aspect of the present invention to provide an optical element that can achieve the effect that conventionally requires two optical elements to achieve.

More particularly, the present invention provides an optical element for diffusing and focusing light. The optical element comprises an optical substrate and a plurality of convexes thereon, wherein the convexes are micrometer-scaled or smaller pyramid structures, and wherein the convexes and the optical element are cast in the same mold.

According to one preferred embodiment of the present invention, the convexes of the optical element for diffusing and focusing light are arranged regularly.

According to another preferred embodiment of the present invention, the convexes of the optical element for diffusing and focusing light are arranged irregularly.

According to yet another preferred embodiment of the present invention, the convexes of the optical element for diffusing and focusing light have the same sizes.

According to still another preferred embodiment of the present invention, the convexes of the optical element for diffusing and focusing light have different sizes.

According to another preferred embodiment of the present invention, the convexes of the optical element for diffusing and focusing light are 5 microns or less in size.

According to yet another preferred embodiment of the present invention, the convexes of the optical element for diffusing and focusing light have tops with a blunted surface.

The optical element of the present invention can turn uneven incident light such as, but not limit to, point light sources or linear light sources into planar light source with even brightness. Furthermore, the optical element of the present invention can focus light and therefore increases its forward brightness. Since the present invention reduces the number of the optical elements used, the problem of the light being absorbed by the optical element can be diminished. Therefore, the color saturation of the light can be retained, and the utilization of the light can be increased.

### BRIEF DESCRIPTION OF THE DRAWINGS

The invention can be more fully understood by reading the following detailed description of the preferred embodiments, with reference made to the accompanying drawings as follows:

FIG. 1A is a top view of an optical element according to an embodiment of the present invention, wherein the convexes on the optical substrate have the same sizes and are regularly arranged.

FIG. 1B is a side view of the optical element in FIG. 1A.

FIG. 1C shows a top view of an optical element according to a preferred embodiment of the present invention, wherein the convexes with a pointed tip on their tops are same-sized and are irregularly arranged.

FIG. 1D shows a top view of an optical element according to another preferred embodiment of the present invention, wherein the convexes with a pointed tip on their tops are different-sized and are irregularly arranged.

FIG. 2A is a top view of an optical element according to another embodiment of the present invention, wherein the convexes on the optical substrate are pyramid structures with a blunted surface on the top. The convexes are same-sized and are regularly arranged on the optical element.

FIG. 2B is a side view of the optical element in FIG. 2A.

FIG. 2C shows a top view of an optical element according to a preferred embodiment of the present invention, wherein the convexes with a blunted surface on the top are same-sized and are irregularly arranged.

FIG. 2D shows a top view of an optical element according to another preferred embodiment of the present invention, wherein the convexes with a blunted surface on the top are different-sized and are irregularly arranged.

FIG. 3A to FIG. 3E are cross-sectional side views of the optical element showing a flowchart of a manufacturing method for the optical element with different-sized convexes according to a preferred embodiment of the present invention.

FIG. 4A to FIG. 4G are cross-sectional side views of the optical element showing a flowchart of a manufacturing method for the optical element with the same-sized convexes according to another preferred embodiment of the present invention.

FIG. 5 is a top view of the structure in FIG. 4C.

FIG. 6 is a top view of the metallic mold in FIG. 4E.

### DETAILED DESCRIPTION OF THE PREFERRED EMBODIMENTS

The preferred embodiments of the present invention are described in greater detail below. However, it should be noted that various modifications and variations can be made to the present invention without departing from the scope or spirit of the invention. The embodiments provided herein are for description of the use and manufacture of the present invention and should not limit the scope of the claims.

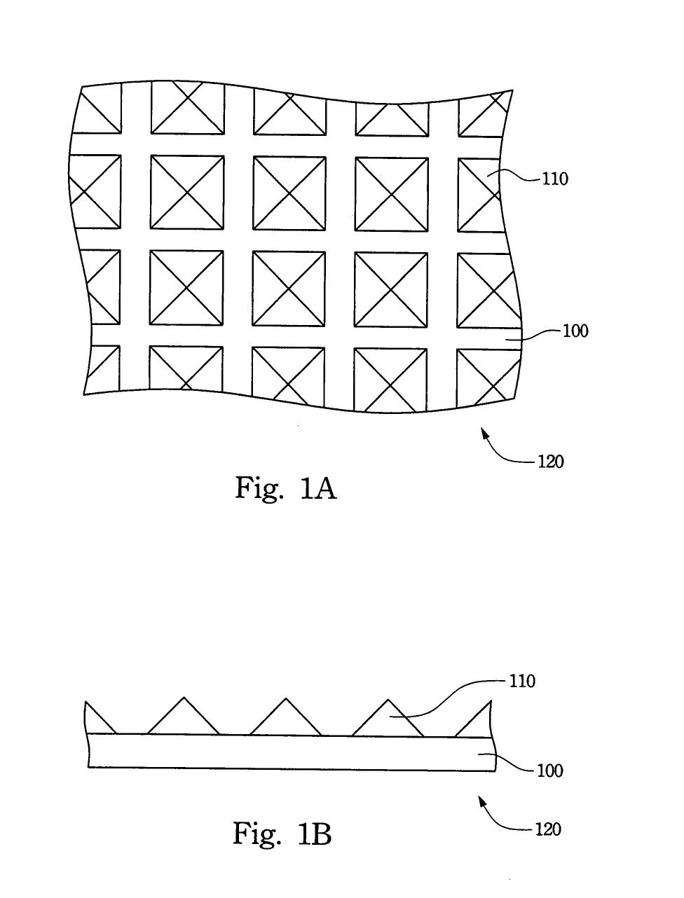

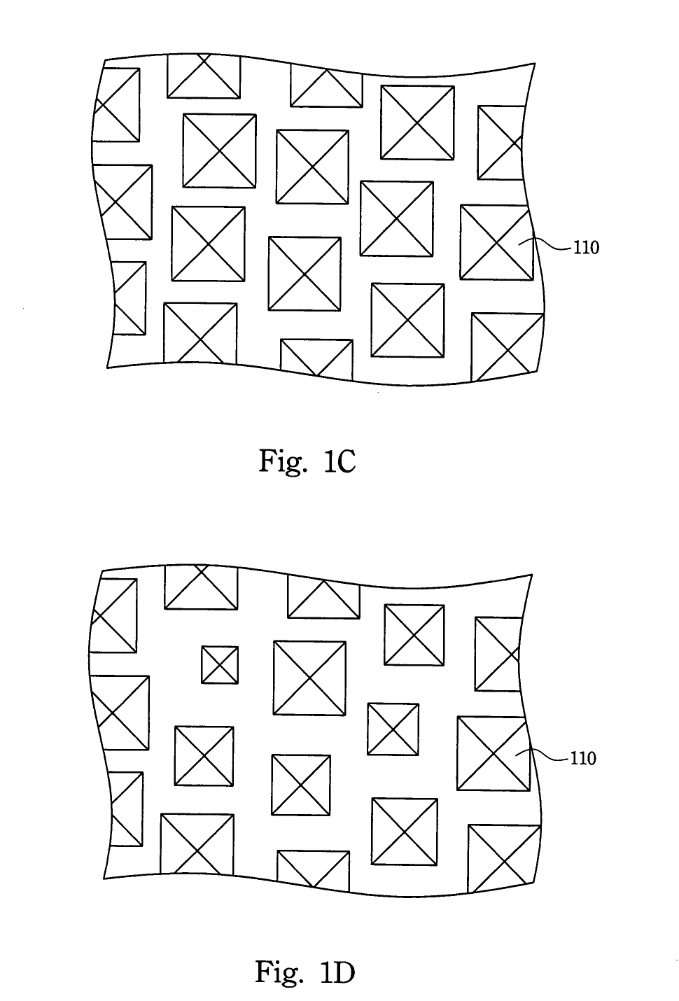

Reference is made to FIG. 1A, which depicts a top view of an optical element according to a preferred embodiment of the present invention, and to FIG. 1B, which is a side view of the optical element in FIG. 1A. An optical element 120 comprises an optical substrate 100 and convexes 110, each located on the optical substrate 100 and having a pointed tip on the top, wherein the convexes 110 with a pointed tip on the top and the optical substrate 100 are cast in the same mold. Preferred materials for the optical element mentioned above are those having high transparency in visible light, such as glass, polyester and the like. The convexes 110 with a pointed tip on the top are micrometer-scaled or smaller pyramid structures, preferably pyramid structures sized 5 microns or less.

Although the convexes 110 with a pointed tip on the top shown in FIG. 1A and FIG. 1B are same-sized and arranged regularly, the sizes and the arrangement of the convexes 110 can also be irregular and are not limited by FIG. 1A and FIG. 1B. Referring to FIG. 1C, which shows a top view of an optical element according to a preferred embodiment of the present invention, the convexes 110 with a pointed tip on their top are same-sized and are irregularly arranged. FIG. 1D shows a top view of an optical element according to another preferred embodiment of the present invention, wherein the convexes 110 with a pointed tip on their top are different-sized and are irregularly arranged.

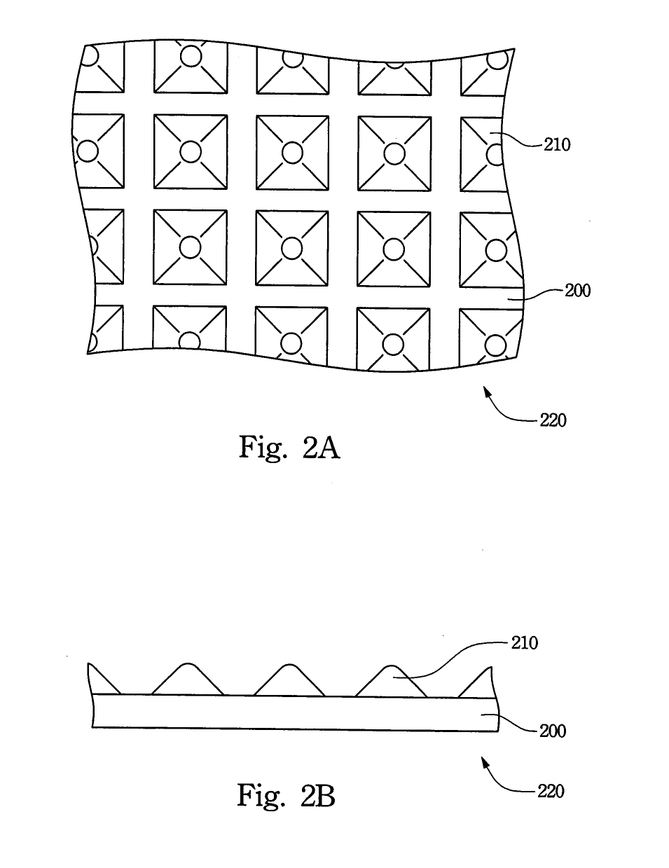

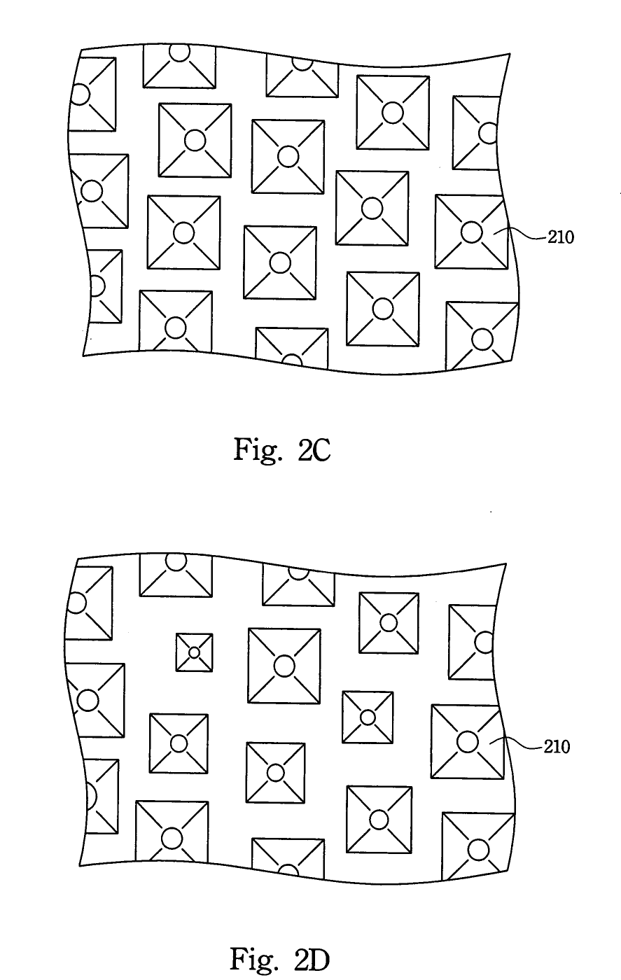

FIG. 2A is a top view of an optical element according to another embodiment of the present invention, and FIG. 2B is a side view of the optical element in FIG. 2A. An optical element 220 comprises an optical substrate 200 and a plurality of convexes 210, each located on the optical substrate 200 and having a blunted surface on the top, wherein the convexes 210 with a blunted surface on the top and the optical substrate 200 are cast in the same mold. Preferred materials for the optical element mentioned above are those having high transparency in visible light, such as glass, polyester and the like. The convexes 210 with a blunted surface on the top are micrometer-scaled or smaller pyramid structures with a blunted surface on the top; preferably, the sizes of the pyramid structures with a blunted surface on the top are 5 microns or less.

Although the convexes 210 with a blunted surface on the top shown in FIG. 2A and FIG. 2B are same-sized and arranged regularly, the sizes and the arrangement of the convexes 210 can also be different and irregular and are not limited by FIG. 2A and FIG. 2B. Referring to FIG. 2C, which shows a top view of an optical element according to a preferred embodiment of the present invention, the convexes 210 with a blunted surface on the top are same-sized and are irregularly arranged. FIG. 2D shows a top view of an optical element according to another preferred embodiment of the present invention, wherein the convexes 210 with a blunted surface on the top are different-sized and are irregularly arranged.

An exemplary manufacturing method for the optical elements of the present invention are described below and should not be regarded as limiting the present invention.

Manufacturing of an Optical Element with Different-Sized Convexes Thereon

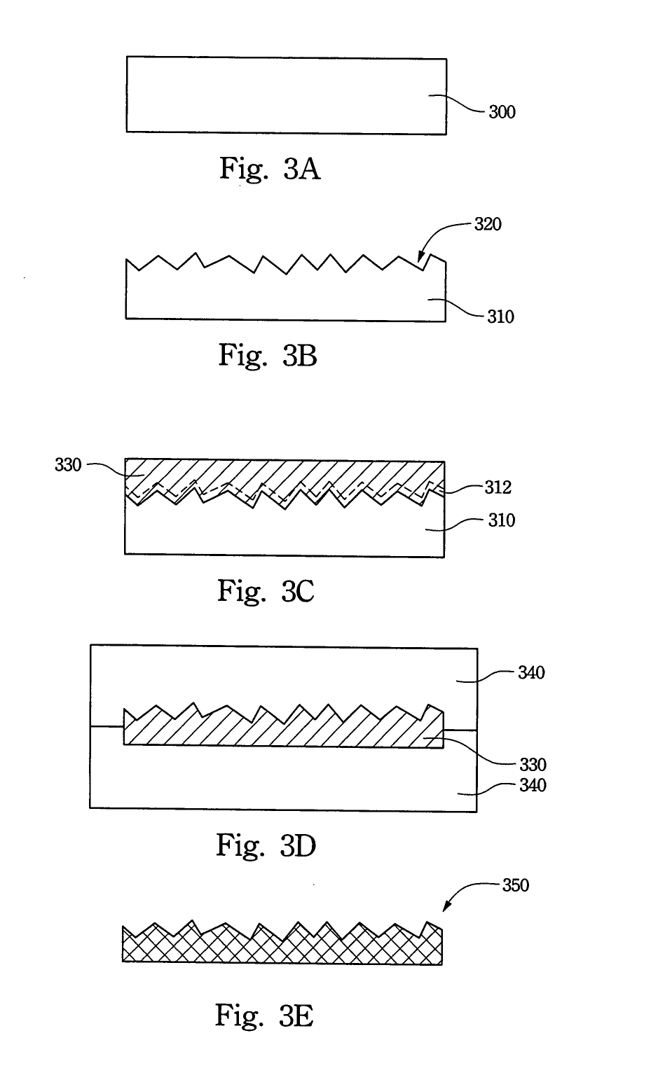

FIG. 3A to FIG. 3E are cross-sectional side views of an optical element showing a flowchart of a manufacturing method for an optical element with different-sized convexes according to a preferred embodiment of the present invention. First, as shown in FIG. 3A, a wafer 300 is provided. The wafer 300 may be an N⁺-type or P⁺-type wafer. According to a preferred embodiment of the present invention, a silicon wafer 300 with a Miller index <100> is used.

In FIG. 3B, the oxide formed on the surface of the silicon wafer 300 is first removed and then an anisotropic etching solution is applied to the silicon wafer 300 to perform an anisotropic etching. Since the anisotropic etching solution has a higher etching rate on the <100> face than on the <111> face of the silicon wafer, grooves 320 with a pyramidal shape are formed after the etching process, whereby the silicon wafer 300 becomes master mold 310. Since the surface of the silicon wafer 300 is not overlaid with any mask having regular patterns before the etching process, pyramid-shaped grooves 320 with various sizes are formed on the surface of the silicon wafer 300 after the etching process. By adjusting the parameters for the etching process, such as the duration of the etching process, the temperature of the etching process, the concentration of the etching solution or the type of the etching solution, grooves with a concave or pointed bottom can be formed. The anisotropic etching solution mentioned above can be, for example, potassium hydroxide (KOH) solution, tetramethyl ammonium hydroxide (TMAH) solution or ethylene diamine pyrocatechol (EDP) solution.

FIG. 3C depicts a modeling process for transferring the pattern of the master mold 310 to a metallic mold 330. In order to make the master mold 310 conductive so that an electroforming process can be performed, a conductive layer 312 is first formed on the master mold 310 by a sputtering or evaporation method. The materials used to form the conductive layer 312 can be any metallic materials that have conductivity. Then, the master mold 310 is immersed in an electrobath to perform an electroforming process known in the art to form the metallic mold 330.

FIG. 3D shows a well-known method for manufacturing a mold 340 from the metallic mold 330. Subsequently, the mold 340 is used to mass-produce the optical element 350 in FIG. 3E by thermal pressing or injection molding.

Manufacturing of an Optical Element with the Same-Sized Convexes Thereon

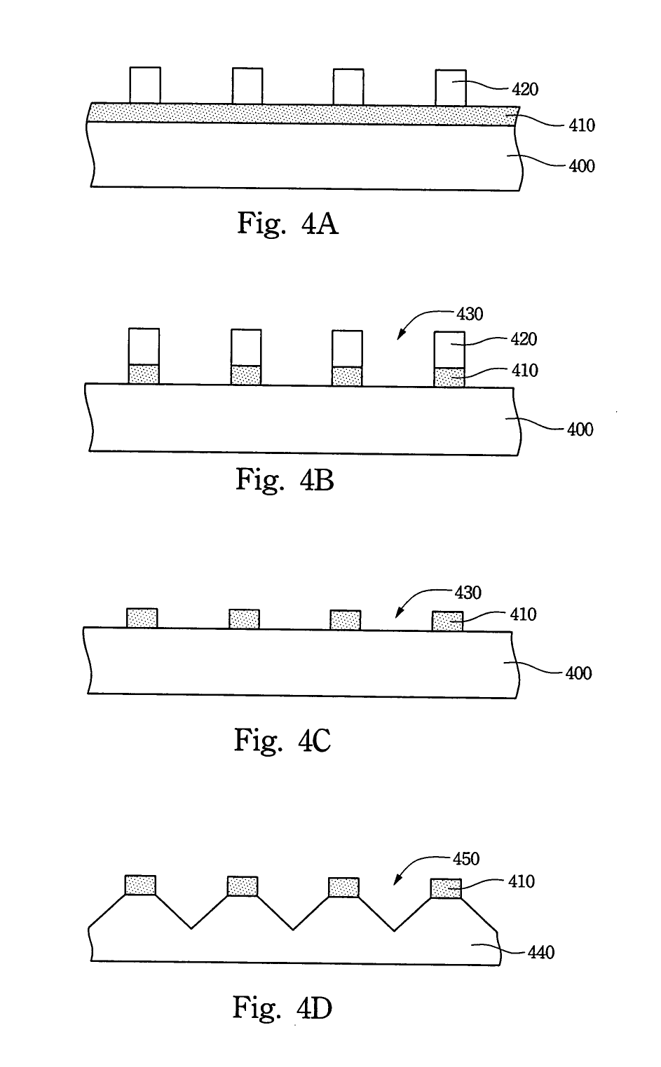

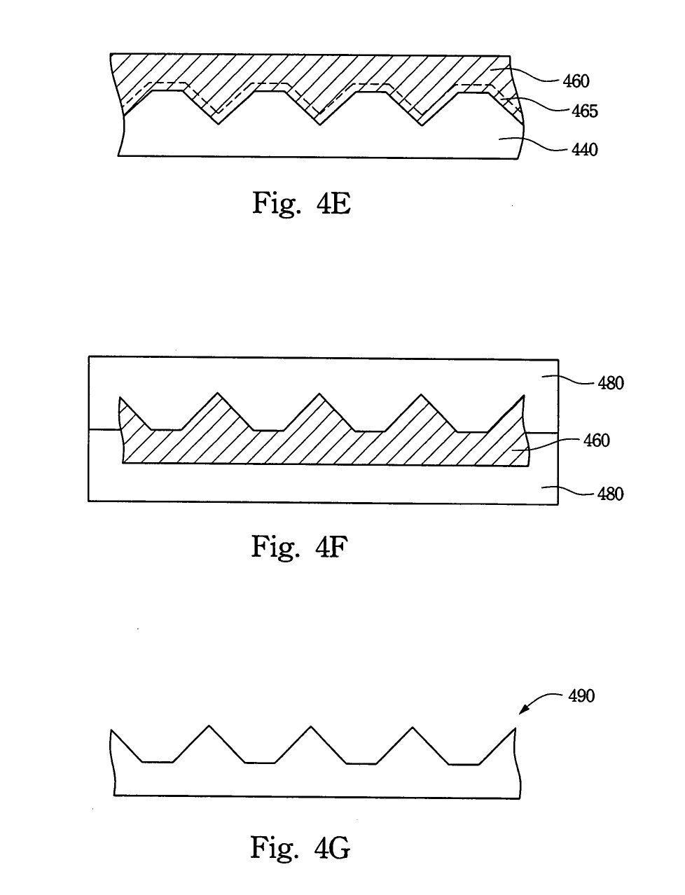

FIG. 4A to FIG. 4G are cross-sectional side views of an optical element showing a flowchart of a manufacturing method for an optical element with same-sized convexes according to another preferred embodiment of the present invention. First, as shown in FIG. 4A, a wafer 400 is provided. According to a preferred embodiment of the present invention, a silicon wafer 400 with a Miller index <100> is used. Then, an oxidation process, or other process known in the art, is performed to form a silicon oxide layer 410 over the silicon wafer 400. Next, a photoresist layer is formed over the silicon oxide layer 410 by spin coating or other well-known process. An exposure process and a development process are then performed to form a patterned photoresist layer 420.

Next, as shown in FIG. 4B, an etching process is performed on the silicon oxide layer 410 using the patterned photoresist layer 420 as a mask. The etching process can be a wet or dry etching process. According to the preferred embodiment, a wet etching process using ammonium fluoride and hydrofluoric acid solution is performed to transfer the pattern of the photoresist layer 420 to the silicon oxide layer 410, whereby forming openings 430 in the silicon oxide layer 410.

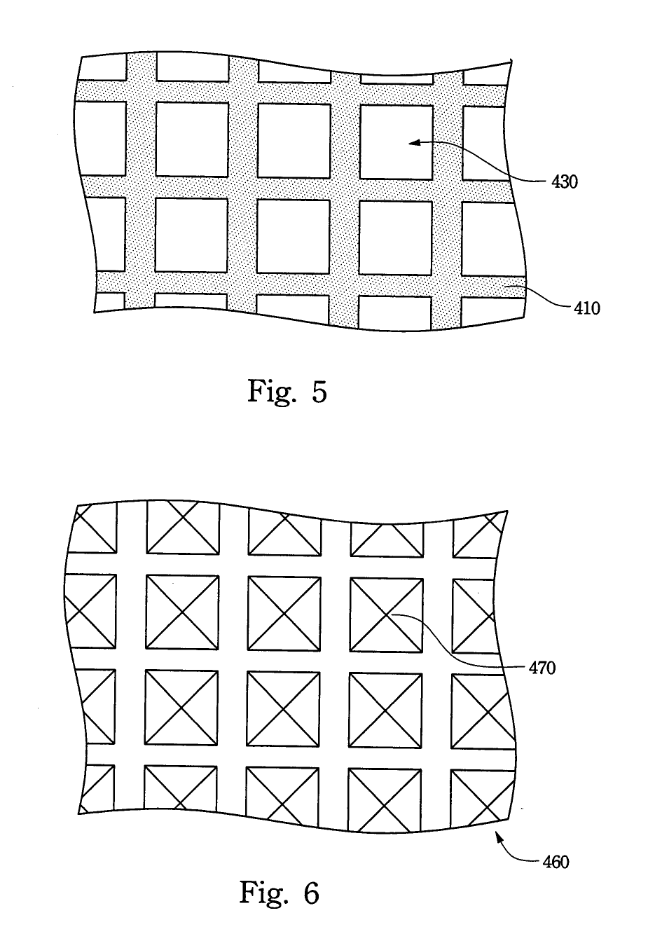

Reference is made to FIG. 4C and FIG. 5, where FIG. 5 is a top view of the structure in FIG. 4C. After the etching process, a conventional method is performed to remove the photoresist layer 420, leaving the patterned silicon oxide layer 410 behind. Since the purpose of the present embodiment is to form a mold with same-sized pyramidal structures thereon, tetragonal openings 430 having the same area are formed on the wafer 400 by the patterned silicon oxide layer 410, as shown in FIG. 5. In FIG. 4D, the patterned silicon oxide layer 410 is used as a mask in the wet etching process to wet etch the silicon wafer 400. In the present embodiment, KOH solution is used to anisotropically etch the silicon wafer 400 so as to form pyramid-shaped grooves 450 on the silicon wafer 400. In other embodiments, the anisotropic etching solution such as TMAH solution or EDP solution may also be used to perform the etching process. Although the bottoms of the grooves 450 shown in FIG. 4D are pointed, the bottoms of the pyramid-shaped grooves 450 can be made concave by adjusting the parameters for the etching process, such as the duration of the etching process, the temperature of the etching process, the concentration of the etching solution or the type of the etching solution. Finally, the patterned silicon oxide layer 410 is removed to form the master mold 440.

FIG. 4E depicts a modeling process for transferring the pattern of the master mold 440 to a metallic mold 460. First, a conductive layer 465 is formed on the master mold 440 by a sputtering or evaporation method as mentioned above. Then, the master mold 440 undergoes a conventional electroforming process to form the metallic mold 460. Reference is made to FIG. 6, which is a top view of the metallic mold 460 in FIG. 4E. Since the mask of the present embodiment, i.e. the patterned silicon oxide layer 410 shown in FIG. 5, defines openings 430 having the same area, pyramid-shaped grooves with the same size are formed on the silicon wafer after the etching process. Therefore, the metallic mold 460 formed has a plurality of pyramid structures 470 regularly arranged thereon, as shown in FIG. 6. As discussed in FIG. 4D, when the bottoms of the pyramid-shaped grooves 450 formed in FIG. 4D are pointed, the tops of the pyramid structures 470 are pointed. Conversely, when the bottoms of the pyramid-shaped grooves 450 formed in FIG. 4D are concave, the tops of the pyramid structures 470 are blunted.

FIG. 4F shows a conventional method for manufacturing a mold 480 from the metallic mold 460. Subsequently, the mold 480 is used to mass-produce the optical element 490 in FIG. 4G by compression or injection molding.

The aforementioned methods are only some of the various manufacturing methods. Other semiconductor processes may also be employed in the present invention to form master molds with different structures.

The optical properties of the optical element of the present invention were tested. The optical element of the present invention shows 71% diffusion and increases the brightness of the light by 150%. The term “diffusion” means the percentage of light diffusely scattered compared to the total light transmitted. That is, the optical element of the preferred embodiment of the present invention scatters 71% of the incident light and increases the brightness by 1.5 times.

Accordingly, the optical element of the present invention not only can turn uneven incident light such as, but not limited to, point light sources and linear light sources into planar light sources with even brightness, but also can increase the forward brightness. Therefore, the optical element of the present invention can achieve the effect that conventionally requires two optical elements to achieve. That is, the optical element of the present invention has both functions of diffusing and focusing light.

The preferred embodiments of the present invention described above should not be regarded as limitations to the present invention. It will be apparent to those skilled in the art that various modifications and variations can be made to the present invention without departing from the scope or spirit of the invention. The scope of the present invention is as defined in the appended claims.

What is claimed is:

1. A method for manufacturing an optical element, comprising the steps of:
anisotropic etching a wafer to form a master mold;
transferring the pattern of the master mold to a metallic mold; and
producing the optical element by thermal pressing with the metallic mold or by injection molding with the metallic mold.

2. The method of claim 1, further comprising:
forming a silicon oxide layer on the wafer before anisotropic etching the wafer.

3. The method of claim 2, further comprising:
patterning the silicon oxide layer to form openings in the silicon oxide layer.

4. The method of claim 3, further comprising:
removing the silicon oxide layer after anisotropic etching the wafer.

5. The method of claim 1, wherein the transferring step comprises:
forming a conductive layer on the master mold; and
immersing the master mold in an electrobath to perform an electroforming process to form the metallic mold.

6. The method of claim 1, wherein the wafer is a silicon wafer.

7. The method of claim 1, wherein the wafer is anisotropic etched by an etching solution of potassium hydroxide, tetramethyl ammonium hydroxide or ethylene diamine pyrocatechol.
